(19) United States
(12) Patent Application Publication
(10) Pub. No.: US 2008/0059624 A1
(43) Pub. Date: Mar. 6, 2008

(54) Method and system for protected calculation and transmission of sensitive data

(76) Inventors: Marc Michael Groz, Stamford, CT (US); Harold J. Teichman, Rutherford, NJ (US); John Francis Barry IV, Riverside, CT (US)

Correspondence Address: Marc M. Groz, Apt 5-1602, 1450 Washington Blvd., Stamfor, CT, 06902, US

(21) Appl. No.: 11/894,936

(22) Filed: Aug. 22, 2007

Related U.S. Application Data
(60) Provisional application No. 60/839,239, filed on Aug. 22, 2006.

(51) Int. Cl. G06F 15/173

(52) U.S. Cl. 709/223

(57) ABSTRACT

A method and system is disclosed for protected calculation and transmission of sensitive data. The method and system address the problems that arise when calculations must be performed using data that is too sensitive to be seen by others. Applications of the method and system include trading, portfolio management, risk management, auctions, and testing of sensitive military or government data. Two prototypes are described.

### CROSS REFERENCE TO RELATED APPLICATIONS

This application claims benefit of U.S. patent application Ser. No. 10/736,464, filed Dec. 14, 2003.

This application claims benefit of U.S. Provisional Patent Application No. 60/782,163, filed Mar. 14, 2006.

This application claims benefit of U.S. Provisional Patent Application No. 60/839,239, filed Aug. 22, 2006.

### BACKGROUND OF THE INVENTION

There are many instances in which commerce and/or other valuable activities are inhibited by the reluctance of one or more parties to show information. Despite the wide availability of encryption, information may become vulnerable whenever it is decrypted for processing purposes. For example, during an auction, when one or more potential buyers submits one or more bids on one or more items, said potential buyers may wish to safeguard information about the amounts, number, and timing of their bids. Winners may wish to reveal only the minimum information necessary to complete transactions. Depending upon the type of auction, said minimum may be that said winners were the highest bidders for their respective winning transactions.

Sometimes, said reluctance to share information may be overcome by the introduction of one or more parties (“honest brokers”) whose role is to act as neutral intermediaries among a plurality of other parties. Even with the addition of one or more honest brokers, however, there may still be circumstances in which the information is of such great value as to inhibit said activities. To illustrate, consider what happens when a professional money manager wishes to unload a large block of stock. Traditionally, said money manager might have attempted to move into the market slowly, testing the waters with small sales divided up amongst many brokers. This strategy may have worked sometimes, but other times may have led to large opportunity costs as news got out that a large amount of a particular stock was being sold. As an alternative, some money managers have turned to automated systems that match up buyers and sellers. Said systems may protect the anonymity of said buyers and sellers, and may also promise to keep confidential some or all of the information provided by said buyers and sellers to said system. Nonetheless, said system, and the parties responsible for it, remain a point of potential vulnerability and information leakage, either from inadequate system security, malicious insiders, malicious hackers, computer viruses, or other rogue programs.

In addition to protecting actual trades being worked in the market, there is a great need for protection of so-called “indicative data” that describes a market participant's inclination to buy or sell at various prices, in various quantities, and according to other criteria. The more access a market participant has to data on actual and/or desired trades, the better is his or her position in said market. Yet there are times when one or more market participants may wish to use third-party data/software to analyze indicative and/or other proprietary data, without sharing said proprietary data with said third parties. Likewise, said third parties may wish to license their data/software to said market participants without relinquishing control of said data/software.

Another example of a situation in which sensitive data is vulnerable to misuse also arises in the investment management business. Investors have a legitimate need to know the risk that money managers are taking with their money. Money managers have a legitimate need to guard against misappropriation of their investment strategies that may be facilitated through detailed knowledge of their holdings. Current approaches to this problem include providing summary level information only (to guard against strategy duplication) and interposition of a neutral risk system provider who gains detailed access to position-level information, using this only to provide summary level information to the investor that is calculated by a neutral intermediary. The problem with the former approach is that the summary information is not independently calculated, while the later approach runs the risk of leakage and misuse of the detailed information about positions (by the “neutral intermediary” or other parties) that can be used to the detriment of the manager (and by extension, its clients).

Although it is seldom discussed, the inverse of the above situation is also problematic for investment management. In order to best serve their clients, investment managers need detailed information about said clients other investments and preferably, present and future liabilities. Said clients, however, may be unwilling or unable to share this information, either out of concern that it may be misused or because they do not have access to it themselves—other investment managers may be refusing to share it with them.

Examples such as these, along with many other situations involving sensitive scientific, commercial, or government data, suggest a need for a method and system for safe calculation and data transmission.

### BRIEF DESCRIPTION OF THE INVENTION

As noted above, what is needed is a safer way to share information that may need processing without negative consequences to the information provider. The present invention provides such a mechanism.

We may define an Isomorphism Server (“IsoServer”) as an active software/system component or module, which may be linked to one or more physical devices. Said IsoServer may reside or otherwise be associated with computer and related hardware which may include without limitation:
electronic computers
optical computers
biological computers
quantum computers capable of operating with qubits and entangled states.

In a preferred embodiment, an IsoServer may be implemented as an internet/web agent, i.e., as a persistent, active software/system component with the capacity to communicate, perceive, reason, and act within its environment. The environment of said IsoServer may include one or more computer and/or communications networks including public networks, private networks, and the internet. Said environment may also include the physical environment of one or more physical devices to which said IsoServer may be linked. Said IsoServer may interact with other internet/web agents and with other physical devices.

An IsoServer may be represented abstractly as
I(x₁, . . . , xₙ), where x₁, . . . , xₙ are inputs and/or state variables of IsoServer I.

### BRIEF DESCRIPTION OF THE DRAWINGS

The above summary of the invention will be better understood when taken in conjunction with the following detailed description, FIG. 1, and FIG. 2 (the “Drawings”), in which:

FIG. 1 is a block diagram of an architecture suitable for implementing the present method and system; and

FIG. 2 is a flow diagram suitable for implementation of a preferred embodiment of the present invention.

### DETAILED DESCRIPTION OF THE INVENTION

IsoServers facilitate safe calculations by exchanging information with other entities, which we shall designate IsoClients. IsoClients may (for example and without limitation) include people, programs, internet agents, web agents, robots, machines, software devices, firmware devices, hardware devices, electronic computers, biological computers, optical computers, quantum computers, or combinations thereof.

One or more IsoClients may issue a request for service to one or more IsoServers. Alternatively, one or more IsoServers may initiate an interaction by offering services to one or more IsoClients. Said offer may be based upon information about said IsoClients that is or becomes available to said IsoServers.

In either case, once said IsoServers and IsoClients are in communication, one or more of said IsoClients may request one or more specific services from one or more IsoServers. Said services may include provision by said IsoServers of Isomorphism Programs (“IsoProgs”) to said IsoClients.

An IsoProg is a program that implements a mathematical function that preserves one or more relationships among one or more data sets. Said IsoProg is used to create “IsoData,” i.e., data upon which additional calculations may be safely performed by one or more parties with whom IsoClients do not wish to share their unprotected data (“Raw Data”).

We say that IsoData is “obfuscated” data and refer to the process by which RawData becomes IsoData as “data obfuscation” or simply “obfuscation.” We also say that IsoProgs act to “obfuscate” RawData into “IsoData”.

Examples of Raw Data that may be operated on by one or more IsoProgs to form IsoData include: statistical data (both numeric and non-numeric); other numeric data; other non-numeric data, such as text, still images, moving images, other multimedia data; maps; models (physical and/or abstract); program code (source and/or object); and symbolic expressions, such as equations, chemical formulae, and the like.

As described in what follows, the method and system use IsoProgs obtained by IsoClients from IsoServers to create IsoData from Raw Data. Said IsoData may be processed by parties who never get access to said Raw Data or said IsoProg. We shall call said parties minimum information clients (“MinClients”). IsoData received by said MinClients may be transformed by an allowed class of other programs (“HeteroProgs”) by one or more MinClients and/or IsoClients. In a preferred embodiment, said HeteroProgs may change Initial IsoData directly into a final encrypted data set, referred to as “Final IsoData”. After the creation of said Final IsoData, it may be transmitted to one or more IsoServers and/or IsoClients for conversion back into an undisguised form of data called Final Data using the inverse function of the IsoProg (“InvIsoProg”). Said Final Data is identical to the outcome that would have been obtained by the MinClient using said HeteroProgs, if it had been given access to the Raw Data. In an alternative preferred embodiment, said HeteroProgs may change Initial IsoData directly into unencrypted Final Data.

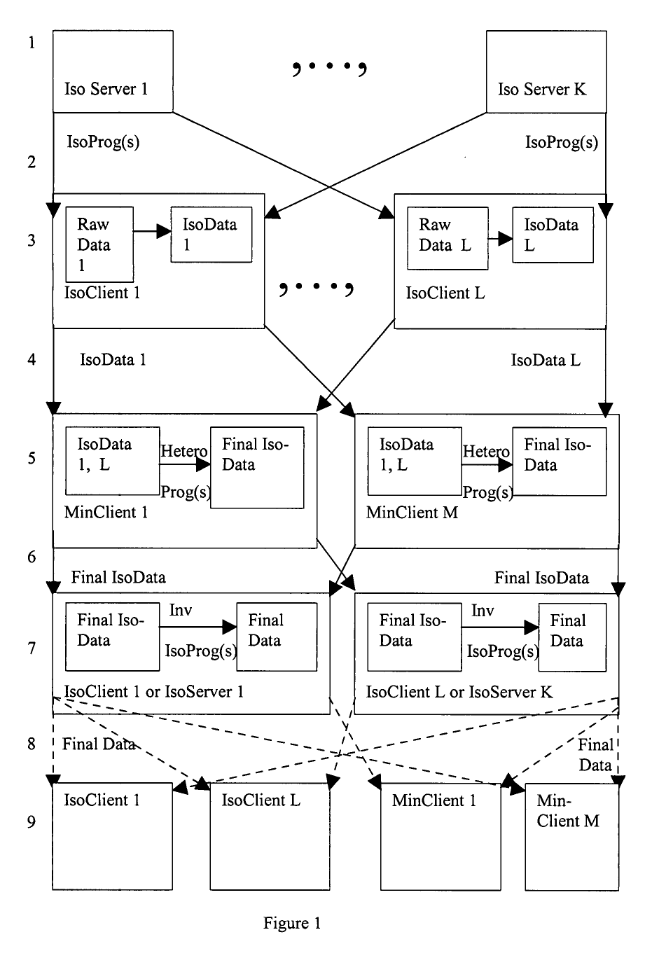

A suitable architecture for implementing the present method and system is shown in FIG. 1. As shown in FIG. 1, the architecture comprises one or more IsoServers (row label 1) sending one or more IsoProgs (row label 2) to one or more IsoClients (row label 3). As shown in row 3, said IsoClients use said IsoProgs to transform one or more collections of Raw Data into one or more collections of IsoData. In row 4, this IsoData is transmitted to one or more MinClients (row 5). In row 5, said MinClients operate on said IsoData with one or more HeteroProgs to generate one or more collections of FinalIsoData. In row 6, said FinalIsoData is sent to one or more IsoServers and/or IsoClients (row 7) where one or more InvIsoProgs converts FinalIsoData into FinalData.

In row 8, said Final Data is transmitted from said IsoServers and/or IsoClients to one or more IsoClients and/or MinClients (row 9).

In an alternative preferred embodiment, said HeteroProgs may change Initial IsoData into one or more collections of Intermediate IsoData before changing the last collection of Intermediate IsoData into a final data set, referred to as Final IsoData. After the creation of said Final IsoData, it may be transmitted to one or more IsoServers and/or IsoClients for conversion back into an undisguised form of data called Final Data using the inverse function of the IsoProg (“InvIsoProg”). Said Final Data is identical to the outcome that would have been obtained by the MinClient if it had been given access to the Raw Data.

In another alternative preferred embodiment, IsoServers transmit both IsoProgs and InvIsoProgs to IsoClients. MinClients transmit said Final IsoData directly to said IsoClients which apply InvIsoProgs to the FinalIsoData to create FinalData.

Definition. We say that a function F preserves a relationship R among data sets D1, . . . , DN if
R(D1, . . . , DN) if and only if R(F(D1), . . . , F(DN))
   Examples of IsoProgs.

1. A program that implements the function
F(x)=2x³+7x+100
(without rounding error) preserves the dyadic relationships of ‘<’, ‘=’, and ‘>’ among a plurality of binary data sets whose members (the values allowed for x) are positive integers.

2. A program that implements the function
F(x)=−x
Preserves relationships among real data sets that ignore the sign of the number x.

3. A program that implements the function
F(x)=ax,
where a is a positive scalar.

F is an example of a function that preserves relationships among vector data sets that do not depend upon the magnitude of the vector x. Said relationships include angle of separation between paired vectors, which may be considered a vector quotient (quaternion). More generally, measures of correlation among data sets are insensitive to multiplication by a positive scalar.

4. A program that operates on character strings C=c₁, . . . , cₙ by prepending a fixed character string P=p₁, . . . , pₜ before C,
where each pⱼ, cᵢεA={a₁, . . . , aₘ}.
   A is a finite ordered set (called an alphabet). Said program preserves the ordering relation defined by said alphabet.

5. A program that operates on character strings C=c₁, . . . , cₙ by inserting a fixed character string I=i₁, . . . iₜ inside C,
where each iⱼ, cᵢεA={a₁, . . . , aₘ}.
   A is a finite ordered set (called an alphabet). Said program preserves the ordering relation defined by said alphabet.

6. A program that operates on character strings C=c₁, . . . , cₙ by appending a fixed character strings A=a₁, . . . , aₜ after C,
where each aⱼ, cᵢεA={a₁, . . . , aₘ}.
   A is a finite ordered set (called an alphabet). Said program preserves the ordering relation defined by said alphabet.

In a preferred embodiment, the mathematical function is treated as a black box and its contents are never revealed. The associated program code is encrypted during transmission to prevent possible misuse by third parties.)

### EXAMPLES

1. Consider a plurality of parties bidding for an item at auction on a computer network. The winner is the highest bidder at the end of the (single round) auction—there is no reserve price. The minimum bid is $1. The highest bidder pays the mean of the two highest bids. All bidders would prefer that their bid information be protected.

In a preferred embodiment, the auction provider facilitates bidder privacy by allowing bidders to submit IsoBids. Said bidders may submit IsoBids (as defined below) in the following manner: they receive a preferably encrypted IsoProg from an IsoServer. Said IsoProg may execute a linear transformation defined on positive integers; for purposes of example, let's say the function is
F(x)=5x+1000
Said linear transform function preserves the order relation among bids, while disguising their exact relative magnitudes and ratios. Instead of submitting their undisguised bids to the auction, said bidders submit their bids as modified by the IsoProg—we shall call such bids IsoBids.

Continuing the example, if there are three bidders B1, B2, B3, bidding $100, $200, and $300 respectively, then the IsoBids for these bidders are 1500, 2000, and 2500. These are the numbers seen by the auction provider (which may be, for example and without limitation, a computer or a person receiving said IsoBids via electronic mail and performing calculations in a spreadsheet). The auction provider may take an average of the two top bidders IsoBids ((2000+2500)/2=2250), even though said auction provider does not know the true magnitude or even the ratio between the top bidders. This number and the identity of the winner may be transmitted to the IsoServer that may supply an inverse IsoProg that turns the supplied number into the correct amount to be paid by the winning bidder. Continuing the example, the IsoServer executes a program that calculates the inverse linear function
F⁻¹(y)=(y−1000)/5
Which, for y=2250, yields an answer of $250, which is the correct mean of the two highest bids.

2. Consider a highly sensitive commercial, military, or government secret which may include Raw Data sets whose values must not be known to competitors, enemies, or rivals. Suppose that said Raw Data sets is tested by an algorithm T, which compares each of the sets against all of the others to determine which set has the largest single element and which set has the smallest single element. These results may be calculated in a fashion similar to the previous example, using an IsoServer to provide an IsoProg that preserves the order relationships among the Data Sets.

3. Consider data relating to polling studies before an election. The method may be used for statistical analysis of data that protects the Raw Data from interception and leakage to rivals or the media.

4. Consider position level data of a money manager. Said money manager provides encrypted position-level data to a neutral risk system provider (“RSP”). The RSP receives IsoData created by the money manager using IsoProgs. The RSP may preferably receive additional IsoData from trusted third parties, such as data vendors, who also use IsoProgs to create this data. The RSP uses HeteroProgs that calculate Final IsoData from the initial one or more sets of IsoData. Said Final IsoData may be transformed into (unencrypted) Final Data risk measures by the operation of an InvIsoProg. Said operation may preferably be performed by one or more of the following: the RSP; one or more trusted third parties; and/or one or more investors. In an alternative preferred embodiment, the operation of an InvIsoProg is unnecessary, as the FinalIsoData is identical with the unencrypted Final Data.

Imagine that the RSP is required to calculate the volatility (annualized standard deviation) of a given portfolio without knowing the positions in the portfolio. Said RSP receives encrypted security master IsoData from a third party data vendor. (IsoProg is preferably supplied to the data vendor by a party distinct from the data vendor.) Said RSP also receives encrypted holdings IsoData of said money manager. (IsoProg is preferably supplied by a party distinct from the money manager.)

For example, security master data may be encrypted by creating a “one time pad” to identify each security with an unbreakable code. Pricing information may preferably be encoded by mapping a given numeric representation into an alternate numeric representation with non-standard numerals and non-standard base. As an illustration, IBM stock with a price of 100.25, appearing as unencrypted data as

IBM 100.25

becomes

IJK +An_*+

where “IJK” is created by a one time pad operation on “IBM”, and “+An_*+” is the result of transforming “100.25”—-a base ten representation with two decimal places—to a base 64 exponential representation using {−, +, Z, . . . , A, z, . . . , a, 9, . . . , 0} as numerals, “_” to represent exponentiation, and “*” as a minus sign.

Additional information security may be added to the above protocol by scaling all of the holdings and/or prices by one or more hidden parameters.

It is evident that a HeteroProg may be written to calculate volatility of a portfolio whose prices and positions are encrypted in a manner such as illustrated above. In some situations, it may be desirable to provide a module that decrypts the IsoData within a protected environment inaccessible to the RSP, even though running on said RSP's systems. This would allow said RSP to use existing risk programs instead of specially constructed HeteroProgs.

In a preferred embodiment, said RSP would operate on specially designed HeteroProgs to calculate Final IsoData and, after operation with appropriate InvIsoProg, Final Data that would represent said required volatility.

In an alternative preferred embodiment, said RSP would use unencrypted programs to calculate Final IsoData and, after operation with appropriate InvIsoProg, Final Data that would represent said required volatility.

In another alternative preferred embodiment, said RSP would use unencrypted programs to directly calculate Final Data that would represent said required volatility.

IsoServers for safe negotiation and deal-making. In a preferred embodiment, IsoServers may preferably be associated with programmable internet/web agents (preferably linked to physical devices) that scour one or more computer networks (and preferably the physical environment of linked physical devices) for clients. Said IsoServers may link up with other IsoServers to create one or more pools of IsoServers (“P-IsoServers”). Said IsoServers and/or P-IsoServers may negotiate with other web agents (and preferably physical devices) to provide one or more IsoProgs to one or more clients. Said IsoProgs may preferably perform market analysis, risk management, and/or record-keeping functions and/or communicate transactional data, indicative data, and/or other information to other agents or facilities. Transactions, indications of interest, and/or other information may result in changes to the internal state of one or more said IsoProgs or to changes in the ownership and/or custody arrangements of one or more financial instruments. Other web agents (and preferably physical devices) representing actual or potential buyers, sellers, or third parties such as regulators and/or service providers, may negotiate and transact with said IsoServers and/or P-IsoServers.

Use of multiple IsoServers and IsoProgs for error correction and/or enhanced security. In a preferred embodiment, a single IsoServer supplying a single IsoProg to one or more IsoClients may provide sufficient safety and accuracy, preferably supplemented by standard commercial or public domain software programs for verifying the integrity of said IsoProg.

In an alternative preferred embodiment, multiple IsoServers may supply copies of said IsoProg to one or more clients for purposes of error detection and correction. In such case, a plurality of calculations may be performed by one or more clients. Said clients may examine the results of said calculation for consistency.

In another preferred embodiment, a plurality of calculations may be performed by one or more clients using a plurality of IsoProgs on their data to create a plurality of IsoData sets. Said IsoData may be transmitted to one or more IsoServers or P-IsoServers that may implement appropriate reverse functions to check for calculation consistency. Said IsoServers or P-IsoServers my report the outcomes of said calculations to said clients.

[Note: The above-described application may create P-IsoServers that may assemble themselves into one or more redundant, error-correcting IsoServers, allowing said error-correcting IsoServers to help manage negotiations, trade, analyze markets, manage risk, keep records-subject to constraints imposed by the program, other agents, and the environment. The inclusion of physical devices allows human traders, analysts, risk managers, portfolio managers, and others to enter and interact in this environment with human and computer counterparts all over the world—both in physical and virtual space.]

Prototype 1

Following is a detailed example of yet another preferred embodiment, together with a description of a prototype of said embodiment, which was implemented in 2006 (“prototype 1”). In prototype 1, the remotely performed calculation of the statistical correlation between two sets of numbers, may be seen as a particular case of the use of IsoServers with IsoProgs that was indicated in Example 3 of the “Examples of IsoProgs” above. A client organization C wishes to calculate the correlation between the time series of historical proprietary returns from two stocks, say X and Y, using a remote service S, which offers the shared use of superior computing resources and a rich library of calculations. But C does not wish to expose its proprietary data to S (or to other parties), nor does it want the true result of S's calculation, which it is requesting from S, to be available to S.

The problem may be addressed using three “Iso” entities:

(1) an IsoClient IC, which is an executable program furnished by the service provider S to organization C, to be run on C's hardware;

(2) an IsoServer IS, which is a distributed calculation service provided by S and run on S's hardware. IS, in addition to offering the correlation calculation service, is able also to deliver a remote instance of an associated IsoProg (see (3) below) to IC.

(3) an IsoProg IP, which in this case is merged with its own InverseIsoProg, so that IP is capable of performing both a “forward” isomorphism that maps Raw Data—a pair comprised of an X time series and a Y time series—into intermediate (“obfuscated”) IsoData for input to the correlation calculation, and an “inverse” isomorphism that maps S's calculated correlation of the IsoData (the “IsoResult”) back to the true correlation of the Raw Data, the “Raw Result”.

Prototype 1: Randomly Configured IsoProgs

A further feature of this scenario is that the IsoProg IP—whose forward isomorphism, it is assumed, can be formally parameterized by N particular values {Param(i)}, i=1, . . . , N—should be initialized on the client side (that is, on C's hardware that is running a local instance of IP within the address space of a local process IC) with random values assigned to the N values Param(i). The point of this randomization is that only the form of the transformation effected by IP should be known to service S, while the specific parameters used in this particular client's IP-transformation of Raw Data into IsoData should be unknown (and indeed be random) to S. (Note that the specific IP parameters used by the client's instance of IC are also unknown to IC itself, as they are programmatically randomly initialized “private variables”, in the jargon of object-oriented programming.) This randomization in the creation of the IsoData serves further to hide any presumptively identifiable regularities in the Raw Data.

Prototype 1: The Iso Communication Sequence

For simplicity below, we refer to the combination of client C's custom code, which can access its file system, etc., and the executable IsoClient instance running on its hardware to which it issues commands, as a single entity “IC”.

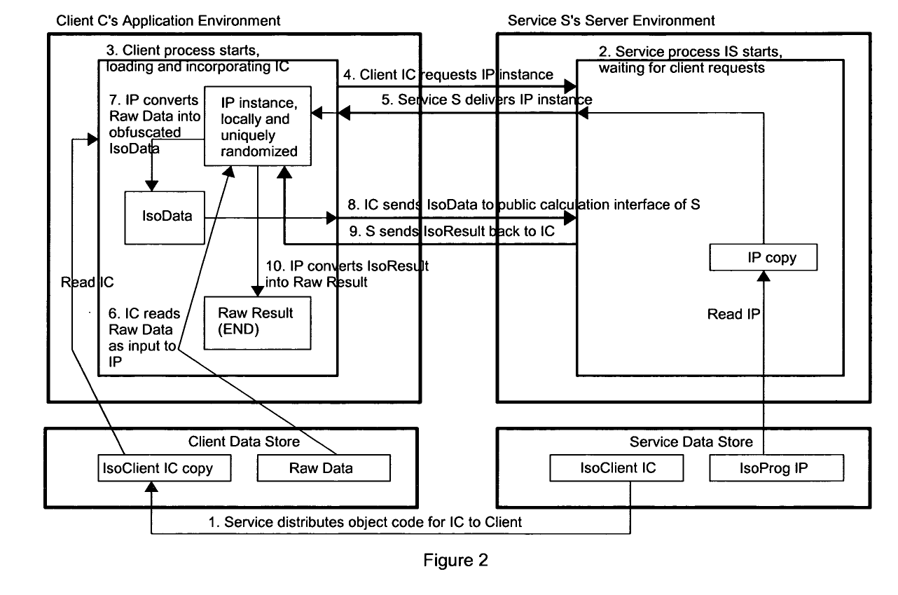

A flow diagram of the Iso Communication Sequence used in prototype 1 is shown in FIG. 2:

In step 1, Client C makes a deal with service S to use S's calculation service to obtain calculated correlations between pairs of stocks. S gives C the executable that is IC and tells C how to use it to access S's correlation calculation.

In step 2, Server S starts process IS and publishes its service name and description for its clients.

In step 3, Client C starts a process running IC on its local hardware. This process will simply be referred to as IC below.

In step 4, IC makes contact with service S, and requests an IsoProg for the correlation calculation.

In step 5, S remotely transmits an IsoProg IP to IC. IP is instantiated in IC's address space and is randomly initialized as described above.

In step 6, IC reads its Raw Data, which is stored locally.

In step 7, IC can now request calculation results from S via the intermediary of its local copy of IP. IC first “obfuscates” its RawData by passing it to IP, which returns the (now unrecognizable) IsoData.

In step 8, IC sends the IsoData (a pair of lists of returns) to S, requesting the correlation value.

In step 9, S computes the correlation value of the IsoData, the IsoResult, and returns it to IC.

In step 10, IC uses its local copy of IP again to “de-obfuscate” the IsoResult into the Raw Result.

At the conclusion of step 10, client C can now do whatever it likes with the desired Raw Result.

It will be observed that the client has hereby performed a calculation whose general specification is public, using a public calculation service, while retaining complete privacy with respect to his proprietary input and output data.

In a preferred embodiment, data obfuscation and de-obfuscation may be performed on Raw Data such that one or more HeteroProgs may perform more compute-intensive operations on IsoData which may preferably make use of distributed computing facilities such as GRIDs, spare cycles of widely dispersed CPUs on the internet as used by the SETI project, etc. For instance, in prototype 1, multiple correlation calculations may use the same randomized rotation angles to increase calculation speed of IC. This may be particularly useful in cases where an enormous number of correlations must be done quickly on data that is too sensitive to share. By streamlining the overhead associated with data obfuscation and de-obfuscation, calculations that are too sensitive to do directly on untrusted computers and too costly to do “in house” may be performed securely using the present invention.

In another preferred embodiment, data obfuscation and de-obfuscation may be performed on Raw Data to facilitate secure use of remotely hosted applications such as spreadsheets, database management systems, word processors, and search engines. For example, an internet-based spreadsheet program may use the present invention to operate with IsoData on the remote host, returning said IsoData to the IsoClient for de-obfuscation into Raw Data. Analogously, a search engine may use the present invention to search using one or more obfuscated queries that may be submitted to one or more suitably modified databases (whose contents have preferably been modified with the same IsoProgs used to obfuscate the one or more queries).

Prototype I: Overview of the Java Implementation

A simple Java implementation of the service sketched above has been developed. The mechanism for interprocess communication between client and service that was used is standard Java Remote Method Invocation (RMI). The mechanism for “bundling up” the IsoProg for delivery to the IsoClient that was used is standard Java Object Serialization. That is, the IsoServer process instantiates an IsoProg object, and serializes it onto a standard Java ObjectOutputStream, which is “piped” via a Socket connection to a corresponding ObjectInputStream residing in the IsoClient process. At the point of reception of the de-serialized IsoProg in the IsoClient process, the IsoProg's private transformation parameters are randomly set.

a. The Forward and Inverse Isomorphisms

The particular forward isomorphism that is performed in this instance on a pair of input arrays (each having the same number of elements, M) given to the calculation server, is a series of successive abstract coordinate rotations in distinct 2-dimensional hyperplanes of the abstract M-dimensional vector space (a subset of R^{M}) defined by the space of possible input arrays. This product of successive abstract rotations is itself a rotation, in formal terms. The point of using a rotation of this sort to transform data that will be subjected to a statistical correlation calculation is that the standard formula for correlation may be seen to involve a vector “inner product” that is left invariant under such transformations. Although the calculated correlation, the IsoResult, is not itself invariant under the rotation, the partial invariance of the correlation formula under rotations opens the door to a simple algebraic inverse transformation of the IsoResult into a Raw Result.

The parameters of the IsoProg's forward transformation, thus, are angles of rotation. We implemented the total forward transformation as the following series of rotations: first, do a rotation through angle Theta1 (of both input arrays/vectors X and Y) in the <X1, X2> and <Y1, Y2> planes; then do a rotation through angle Theta2 in the <X2, X3> and <Y2, Y3> planes, etc. So there are (M−1) angles of rotation in the full rotation. These (M−1) angles are precisely the values that are selected randomly when the IsoProg is received by the IsoClient. The character of the Raw Data is fully “obfuscated” by this means.

In alternative preferred embodiments, the number of rotations may be less or more than in the present example. Fewer rotations may result in data that is somewhat less than fully obfuscated, but may be desirable when performance overhead is an issue.

Those values necessary to re-constitute the Raw Result from the IsoResult are stored as private instance variables in the IsoProg object each time a forward transformation is done. These values are functions of the particular <X, Y> vectors whose correlation is to be calculated. So the use of the forward and inverse transformation capabilities of the IsoProg must be coordinated: after you've transformed a pair of input vectors and requested their correlation, you must apply the inverse transformation to the IsoResult.

b. The Java Classes

There are three main Java classes in the application, corresponding to the pattern outlined above: CorrIsoServer, CorrIsoClient and CorrIsoProg. The signatures of their most important methods are as follows:

public class CorrIsoServer {

public CorrIsoServer(int size)

throws IOException, InterruptedException {

}
public Float calc(ArrayList<Float> xReturns,
ArrayList<Float> yReturns) {
}

}
public class CorrIsoClient {

public CorrIsoClient(String filename)

throws IOException, FileNotFoundException {

}
public void run( )

throws IOException, FileNotFoundException,
ClassNotFoundException,

NotBoundException, InterruptedException {

}

}
public class CorrIsoProg implements Serializable {

private ArrayList<Float> rotate(int firstIx, int secondIx,
double theta,

ArrayList<Float> zr) {

}
public CorrIsoProg(int sizeOfCorrArrays) {
}
public void init(int sizeOfCorrArrays) {
}
public static Float mean(ArrayList<Float> vector) {
}
public static Float stddev(ArrayList<Float> vector) {
}
public ArrayList< ArrayList<Float>>

run(ArrayList<Float> xReturns, ArrayList<Float>
yReturns) {

}
public Float runInverse(Float calcCorrelation) {
}

}

As required by Java RMI, the CorrIsoServer object instance is wrapped in an implementation class, RemoteCorrIsoServerImpl, which implements a public interface that is available to remote clients, RemoteCorrIsoServer:

public interface RemoteCorrIsoServer extends Remote {

public void getIsoProgIS( )

throws RemoteException, IOException, InterruptedException;

public Float calcCorrelation(ArrayList<Float> xs, ArrayList<Float>
ys)

throws RemoteException;

public final static String lookupName = “RemoteCorrIsoServer”;

}

The methods in this interface, as implemented in the remote server object, simply relay their calls to the corresponding methods in the CorrIsoServer instance.

c. The Java Communication Sequence

The sequence of computation in the prototype application mirrors the steps 1-11 above, and goes as follows:

The main( ) method of RemoteCorrIsoServerImpl is run on the server machine, which registers the name of the service with RMI and listens for connections. The main( ) method of CorrIsoClient is executed on the client machine, which instantiates a local CorrIsoClient object whose constructor reads a local file containing the X and Y arrays of returns; main( ) then calls CorrIsoClient.run( ). The latter method contacts the remote server object, and calls RemoteCorrIsoServer.getIsoProgIS( ), to get a CorrIsoProg in the form of an ObjectInputStream. On the server side, a CorrIsoProg is instantiated (if necessary) and serialized on a Socket connection to the client with this call, in order to make it available to the remote client. In the client-side process, the received CorrIsoProg is then randomly initialized. The CorrIsoClient instance goes on to call CorrIsoProg.run( ) to return IsoData from its local Raw Data, and then calls RemoteCorrIsoServer.calcCorrelation(IsoData) to get the IsoResult. It then finishes by calling CorrIsoProg.runInverse(IsoResult) to get the real result, and prints it out.

Prototype 2: Example of Protecting Data and Calculation Simultaneously: “Proof-of-Concept” Documentation

Desired Program Function: Evaluate a user inputted polynomial for a given list of input values, encrypting both the data points to be evaluated and the coefficients and exponents of the polynomial such that a untrusted 3^{rd} party can evaluate the polynomial at the specified points without gaining access to either the coefficients and exponents of the polynomial or the data points themselves. All program components, detailed below, are written in Matlab.
Isoclient Description: The user inputs a polynomial and a data set of x values at which to evaluate the polynomial. The coefficients of the polynomial, the exponents of the polynomial, and the x-values are all stored as vectors. Without loss of generality, we assume that the polynomial is of the form:
   f(x)=a1*xˆ(b1)+a2*xˆ(b2)+a3*xˆ(b3)+ . . .

We will now consider the case to encrypt the evaluation of the polynomial for a single x value. The case for a list of x values can be extrapolated by vectorizing the entire process. We assume the polynomial has n terms. We then call the isoprog to generate n random small odd numbers r1, r2, r3, . . .

For the first x value, f(x1)=a1*x1ˆ(b1)+a2*x1ˆ(b2)+a3*x1ˆ(b3)+ . . .

f(x1) is also equal to [a1ˆ(1/(b1*r1))*x1ˆ(1/r1)]ˆ[b1*r1]+[a2ˆ(1/(b2*r2))*x1ˆ(1/r2)]ˆ[b2*r2]+[a3ˆ(1/(b3*r3))*x1ˆ(1/r3)]ˆ[b3*r3]+ . . .

We create an array of isodata with elements [a1ˆ(1/(b1*r1))*x1(1/r1)], [a2ˆ(1/(b2*r2))*x1ˆ(1/r2)], [a3ˆ(1/(b3*r3))*x1ˆ(1/r3)], . . . and isoexponents [b1*r1], [b2*r2], [b3*r3], . . .
Isoprog Description: The isoprog generates a m by n matrix of random small odd numbers. The m rows are for the m data points and the n columns are for the n terms of the polynomial.
Minclient Description: The Minclient raises each element of the isodata to the corresponding isoexponent and sums them to achieve the evaluation of f(x) for each x value.

Prototype II: Additional Details
Polynomial evaluation can be done for multiple data sets without compromising the identity of the polynomial being evaluated.
Algorithm requires that the minclient trust to some extent that the isoclient will not produce bogus data.
   Tabular Comparison of Invention to Standard Methods

Table 1 shows how standard methods of generating output data from input data operated on by one or more programs differ from the present invention, in terms of what information is available to the one or more computers on which the one or more programs are running, and possibly to one or more people with access to said one or more computers.

TABLE 1
Information Available to One or More Untrusted Computers

| | | | OUT- | |
|---|---|---|---|---|
| | INPUT | ALGO- | PUT | |
| CASE | DATA | RITHM | DATA | COMMENT |
| 1 | Yes | Yes | Yes | Standard Method |
| | | (See | | |
| | | Note 1) | | |
| 2 | Yes | Yes | No | Degenerate Case |
| | | | | (Failed Program) |
| 3 | Yes | No | Yes | Present Invention (See Note 2) |
| 4 | Yes | No | No | Present Invention (See Note 2) |
| 5 | No | Yes | Yes | Present Invention |
| | | | | (Final IsoData = Final Data) |
| 6 | No | Yes | No | Present Invention |
| | | | | (see Correlation Example) |
| 7 | No | No | Yes | Present Invention |
| | | | | (Matlab Example) |
| 8 | No | No | No | Present Invention (See Note 3) |

Notes
1. In standard method, algorithm is “known” to the computer(s) on which it is running, in the form of object code. Such code may be vulnerable to reverse engineering to extract the algorithm, even when source code is not available.
2. Cases 3 & 4 are potentially weaker forms of protection than Cases 7 & 8. They may be useful in situations where the “untrusted computers” are required to verify the input data, even though they are forbidden to know the algorithm operating on that data.
3. Case 8 may be arrived at by a combination of the data and algorithm obfuscation techniques of Cases 6&7.

While the invention has been described in conjunction with specific embodiments, it is evident that numerous alternatives, modifications, and variations will be apparent to those skilled in the art in light of the foregoing description.

We claim:

1. A method for performing calculations and transmitting data safely, said method comprising:
Selecting one or more IsoServers;
Selecting one or more IsoClients, said IsoClients exchanging data and receiving one or more IsoProgs from said IsoServers;
Applying said IsoProgs to one or more collections of RawData to generate one or more collections of IsoData;
Transmitting one or more collections of IsoData to one or more MinClients;
Applying one or more HeteroProgs to one or more collections of IsoData to generate one or more collections of Final IsoData;
Transmitting one or more collections of FinalIsoData to one or more IsoServers and IsoClients;
Applying one or more InvIsoProgs to one or more collections of FinalIsoData to generate one or more collections of Final Data.

2. The method of claim 1, where one or more said IsoServers initiate the exchange of data with one or more of said IsoClients.

3. The method of claim 1, where one or more said IsoClients initiate the exchange of data with one or more of said IsoServers.

4. The method of claim 1, where one or more said MinClients initiate one or more requests for one or more collections of said IsoData from one or more of said IsoClients.

5. The method of claim 1, where one or more said IsoClients initiate one or more offers to send one or more collections of said IsoData to one or more of said MinClients.

6. The method of claim 1, where no more than one of said HeteroProgs is applied to any of said collections of IsoData.

7. The method of claim 1, where a multiplicity of said HeteroProgs is applied to one or more of said collections of IsoData.

8. The method of claim 1, where one or more collections of said Final IsoData is transmitted to one or more of said IsoServers.

9. The method of claim 1, where one or more collections of said Final IsoData is transmitted to one or more of said IsoClients.

10. The method of claim 1, where said InvIsoProgs are applied to one or more collections of said Final IsoData by one or more of said IsoServers.

11. The method of claim 1, where said InvIsoProgs are applied to one or more collections of said Final IsoData by one or more of said IsoClients.

12. The method of claim 1, where one or more of said IsoServers is an internet/web agent.

13. The method of claim 12, where said internet/web agents link up to form one or more P-IsoServers.

14. The method of claim 13, where said IsoServers and P-IsoServers negotiate with counterparties.

15. The method of claim 14, where said counterparties are internet/web agents.

16. The method of claim 14, where said counterparties are physical devices.

17. The method of claim 13, where IsoProgs running on said internet/web agents perform market analysis.

18. The method of claim 13, where IsoProgs running on said internet/web agents communicate transactional information to other agents and/or facilities.

19. The method of claim 1, where a multiplicity of IsoProgs is used to facilitate error correction.

20. The method of claim 1, where a multiplicity of IsoServers is used to facilitate error correction.

21. The method of claim 1, where one or more of said IsoProgs preserves the dyadic relationships of ‘<’, ‘=’, and ‘>’.

22. The method of claim 1, where one or more of said IsoProgs preserves relationships among vector data sets that do not depend upon magnitude.

23. The method of claim 22, where one or more of said IsoProgs preserves the pairwise vector quotients of said vector data sets.

24. The method of claim 1, where said IsoClients use said IsoProgs to create IsoBids.

25. The method of claim 24, where said IsoBids are used in an auction.

26. The method of claim 25, where said auction is conducted over a communications network.

27. The method of claim 26, where said communications network consists of one or more computer networks.

28. The method of claim 1, where highly sensitive data is tested by an algorithm.

29. The method of claim 28, where said data relates to military or other government secrets.

30. The method of claim 1, where said RawData contains information about investments and/or liabilities.

31. The method of claim 30, where said RawData may be used to calculate risk measures.

32. The method of claim 30, where said RawData may be used to generate potential matches among two or more indications of interest.

33. The method of claim 30, where said RawData may be used to generate trades.

34. A system for performing calculations and transmitting data safely, said system comprising:
a means for selecting one or more IsoServers;
a means for selecting one or more IsoClients, said IsoClients exchanging data and receiving one or more IsoProgs from said IsoServers;
a means for applying said IsoProgs to one or more collections of RawData to generate one or more collections of IsoData;
a means for transmitting one or more collections of IsoData to one or more MinClients;
a means for Applying one or more HeteroProgs to one or more collections of IsoData to generate one or more collections of Final IsoData;
a means for transmitting one or more collections of FinalIsoData to one or more IsoServers and IsoClients;
a means for applying one or more InvIsoProgs to one or more collections of FinalIsoData to generate one or more collections of Final Data.
